(19) United States
(12) Patent Application Publication
(10) Pub. No.: US 2003/0079423 A1
(43) Pub. Date: May 1, 2003

(54) Mine door leaf and method of manufacture thereof

(76) Inventors: William R. Kennedy, Taylorville, IL (US); John M. Kennedy, Taylorville, IL (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/003,353

(22) Filed: Nov. 1, 2001

(51) Int. Cl. E06B 1/04

(52) U.S. Cl. 52/204.1; 52/745.15; 52/204.5

(57) ABSTRACT

A mine door leaf of hollow construction with the hollow infilled with a fluent filling material which, when solidified, attaches to the enclosing components of the door leaf.

### BACKGROUND OF THE INVENTION

This invention relates to mine doors, more particularly to mine door leaf constructions especially for relatively large mine doors, and to a method of manufacture thereof.

### SUMMARY OF THE INVENTION

Among the several objects of the invention may be noted the provision of a mine door leaf, and more particularly a relatively large door leaf for hinged support in a door frame in a mine, of relatively light weight for its size and of substantial resistance to stress, being especially of substantial torsional rigidity; the provision of such a door leaf which is resistant to sagging and buckling; the provision of such a door leaf having considerable shear strength so as to avoid cracking under pressure which may be imposed facewise thereon; the provision of such a door leaf which is fire-resistant; the provision of such a door leaf which may be economically fabricated without extensive forming and extensive assembly; and the provision of a method of manufacturing such a door leaf.

In general, a mine door leaf of the invention comprises a central core of a solidified composition, outer panels on opposite faces of the core, the core having a force-transmitting relationship with said panels, the panels and filling constituting an integrated stress-resistant structure, and one or more hinge components on the leaf.

The method of manufacture comprises, in general, positioning two door panels in opposing spaced-apart relation; filling the space with material in a fluent state, the filling material setting in situ to a solid state in force-transmitting relationship with said panels.

Other objects and features will be in part apparent and in part pointed out hereinafter.

### BRIEF DESCRIPTION OF THE DRAWINGS

FIG. 1 is a semi-diagrammatic view in elevation of a door assembly comprising a pair of door leafs of this invention, broken away in part to illustrate the foam infilling of one of the door leafs;

FIGS. 2 and 3 are enlarged vertical and horizontal sections on lines 2—2 and 3—3 of FIG. 1, each broken away in the middle;

FIGS. 4-8 are semi-diagrammatic perspectives illustrating different bracing arrangements that may be used;

FIGS. 9 and 10 are semi-diagrammatic perspectives illustrating double-door leaf assemblies, each embodying door leafs with different bracing arrangements;

FIG. 11 is a view similar to FIG. 1 showing a modification (frameless);

FIGS. 12 and 13 are views similar to FIGS. 2 and 3 showing said modification; and

FIG. 14 is a perspective illustrative of procedure involved in the method of manufacture of the FIGS. 11-13 modification.

Corresponding reference characters indicate corresponding parts throughout the several views of the drawings.

### DETAILED DESCRIPTION OF THE DRAWINGS

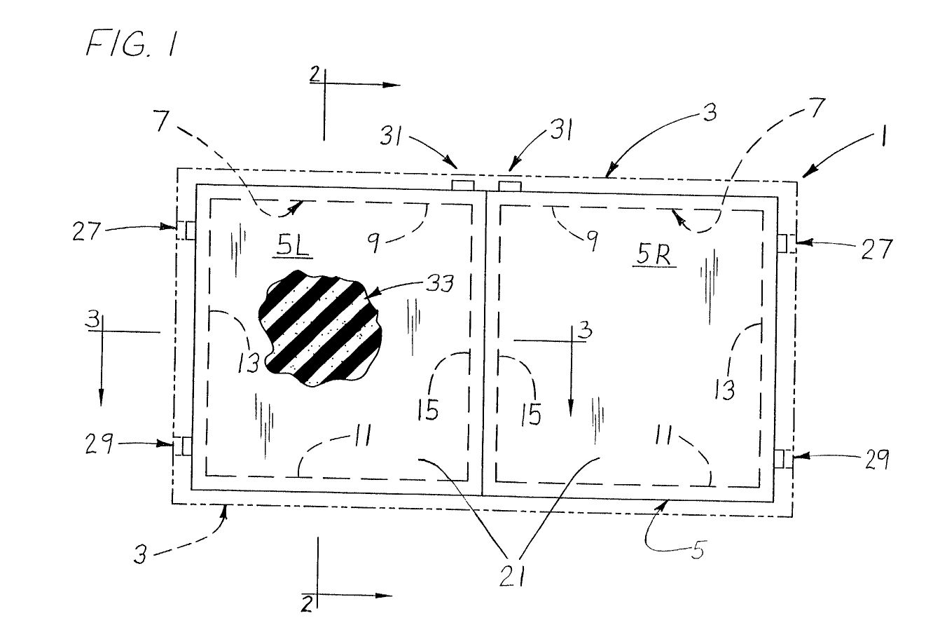

Referring first to FIG. 1 of the drawings, a mine door assembly designated in its entirety by the reference numeral 1 is shown as comprising a rectangular frame 3 (shown in phantom) defining a doorway closed by a door 5 having a left-hand door leaf 5L and a right-hand door leaf 5R (left and right as viewed in FIG. 1), each constructed according to this invention. The door leafs are essentially identical and a description of door leaf 5L should suffice for door leaf 5R.

The door frame 3 can be of any suitable construction, such as the construction disclosed in prior Kennedy U.S. Pat. No. RE. 36,853 wherein the door frame comprises a pair of vertical columns supporting a horizontal lintel. As described in the patent, the columns are vertically adjustable to fit mine passages of different heights and yieldable to accommodate mine convergence without permanent deformation of the door frame. Other door frames may also be used with the mine door assembly of this invention.

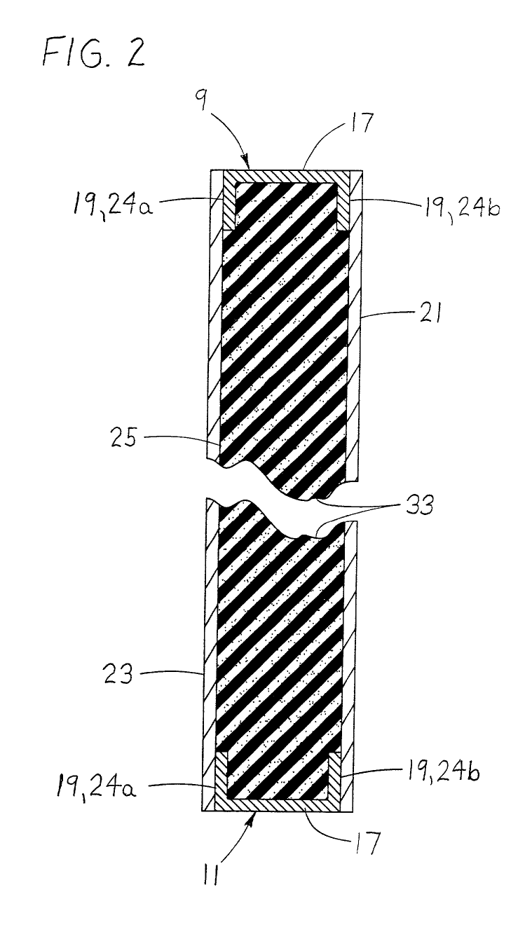

Referring to FIGS. 1-3, the door leaf SL comprises an open rectangular door frame 7 having a top 9, bottom 11 and sides 13 and 15, each comprising a metal bar (e.g., a strip of steel) and being suitably joined at the ends thereof as by welding. As shown, each of the top, bottom and side members is constituted by a length of steel channel having a web 17 and flanges 19, disposed in the frame with the flanges directed inward. (The flanges could also be directed outward). Other types of steel bar may of course be used. Alternatively, structural beams of suitable cross section (e.g., I, Z, T, O) can be used. Still further, hollow metal beams of polygonal cross sectional shape (e.g., rectangular box beams constructed of relatively thin-gage (e.g., 0.25 in. thick or less) sheet metal, for example) can be used. Rigid door panels 21 and 23 are preferably secured (as by welding, bonding or the use of mechanical devices such as fasteners) to the top 9, bottom 11 and sides 13 and 15 of the frame 7 on opposite faces 24a, 24b of the frame, the opposite faces being defined, in the embodiment shown, by the flanges 19 of the top, bottom and side members. The spaced apart panels 21, 23 and the top, bottom and sides of the frame enclose a space 25. Each of the panels may comprise a rectangular sheet of 20 gauge sheet steel, for example, although the precise thickness of metal may vary.

The door frame 7 and door panels 21, 23 can be constructed of non-metal materials, or a combination of metal and non-metal materials, without departing from the scope of this invention. For example, the frame 7 and panels 21, 23 can be constructed of any materials capable of taking the necessary loads in tension and compression, such as wood, fiberglass, high-pressure laminate sheet, plastic sheet and/or cloth.

It will be understood that the door panels can be secured in other ways to the door frame 7, or to inside or outside faces of the frame, to create the space 25. Alternatively, the panels 21, 23 may be unsecured to the frame 7 on the inside of the frame, with the filling (to be described) inside the space 25 serving to hold the panels in fixed position relative to the frame and one another.

Each door leaf 5L, 5R is mounted in the door frame 3 for swinging between closed and open positions by means of one or more hinge components such as a pair of hinges indicated at 27 and 29 at side 13. (The hinges may be of any construction.) Each door leaf is supported in its closed position by engagement of the top 9 of the door frame 7 with the frame 3 of the doorway, or by suitable means 31 mounted on the door frame 3 for engagement with the frame 7.

The space 25 between panels 21, 23 bounded by the top 9, bottom 11 and sides 13 of the frame 7 is generally completely filled with a central core comprising a solidified filling 33 having a force-transmitting relationship with the frame and the panels, the frame, panels and filling constituting an integrated stress-resistant structure. The filling 33 is preferably a polyethylene foam having the propensity of bonding to the panels (and door frame 7) by adhesion thus establishing the force-transmitting relationship therewith, and further being fire-resistant. A polyurethane foam having these attributes and one which is adapted for infilling space 25 and solidifying into a solid relatively light-weight central core having strength in tension and compression is that sold under the name VERSI-FOAM by RHH Foam Systems of Cudahy, Wis. Alternatively, the filling 33 can be foamed cement, gypsum cement, foamed lead, polystyrene or other materials providing the necessary strength characteristics (e.g., in tension, compression and shear). The panels 21, 23 may be treated (e.g., cleaned to remove oil or grease) or provided on their inside faces with means for effecting or augmenting the bonding to establish the force-transmitting relationship. This means can take various forms, including etching, ribs or other irregularities on the inside faces of the panels. Alternatively, wire screen, rebar-type elements or other mechanical coupling devices may be attached to the inside faces of the panels for increasing surface area and/or interference with the filling 33 after it has set. Such mechanical coupling devices may be used in lieu of or as a supplement to adhesion to establish the force-transmitting relationship between the filling 33 and the door panels 21, 23.

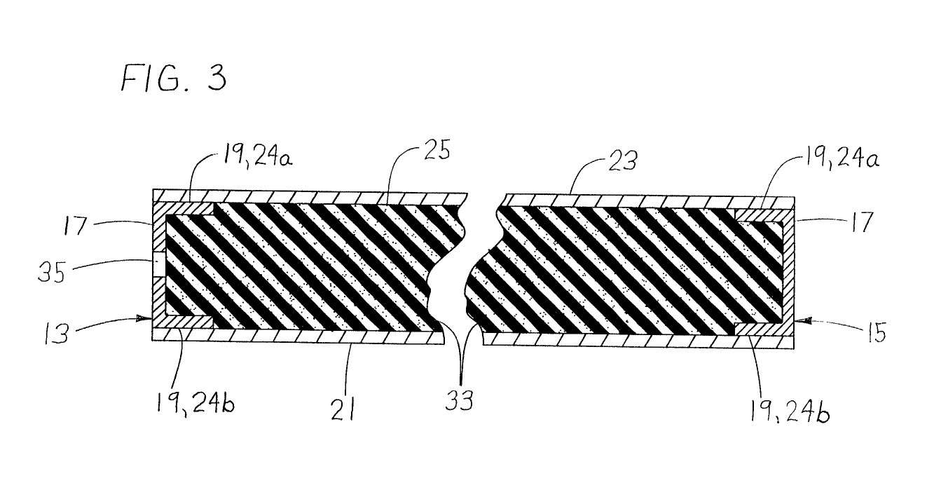

The foam material is one that is initially in a fluent state for being infilled in the space 25 and which sets up from the fluent state to a closed-cell solid state wherein it has strength in tension and compression. It is introduced into the space 25 in the fluent state via one or more filling openings such as indicated at 35 in the frame side member 13 (FIG. 3).

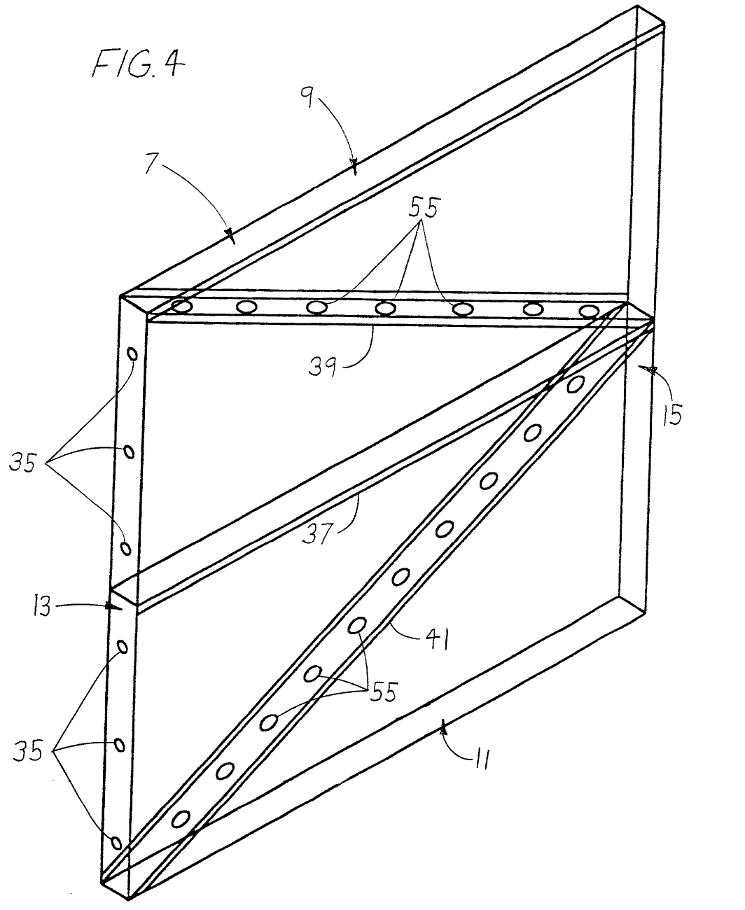

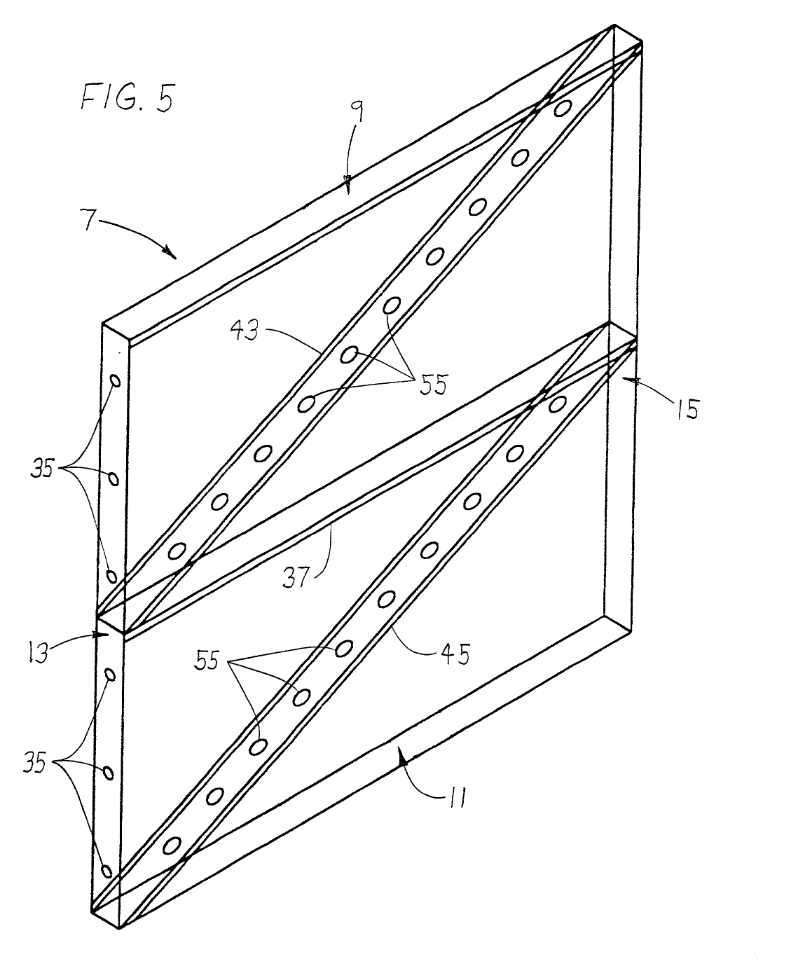

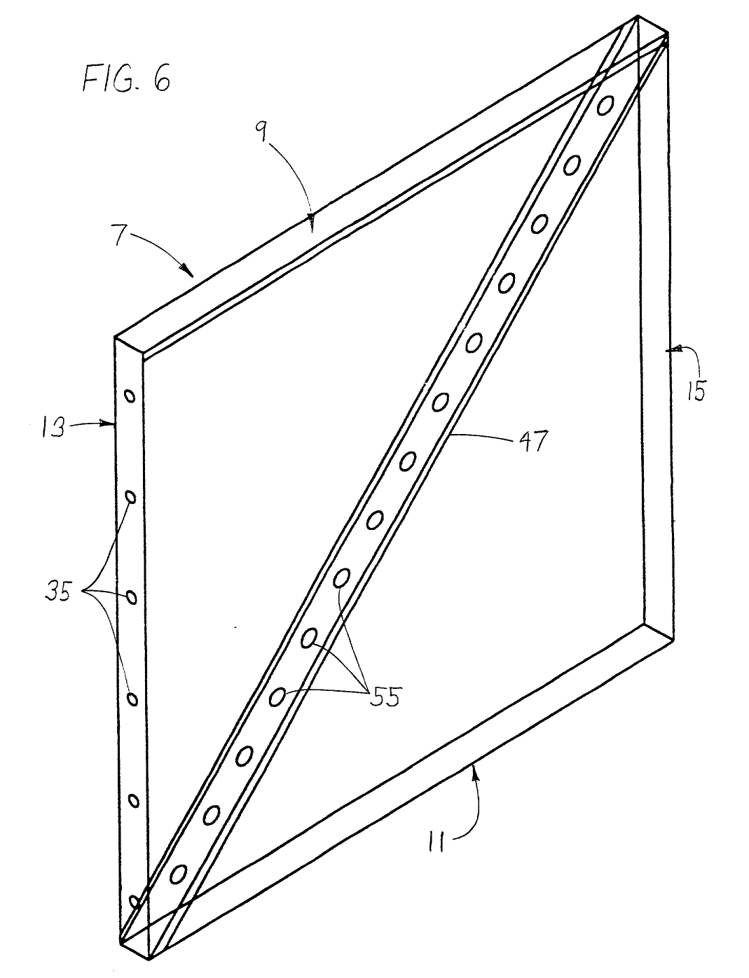

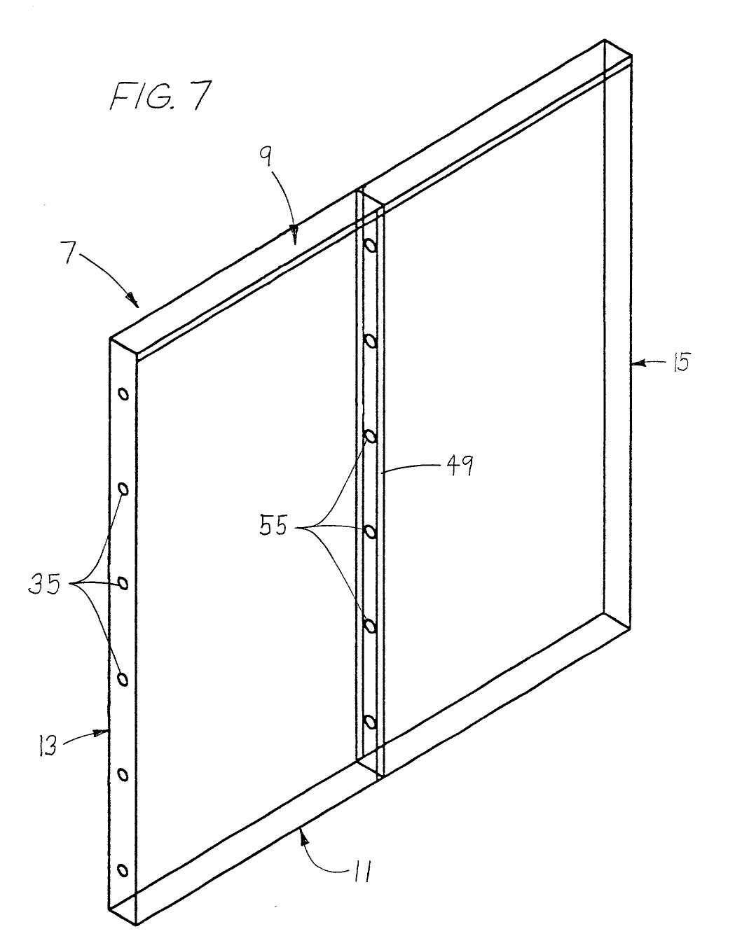

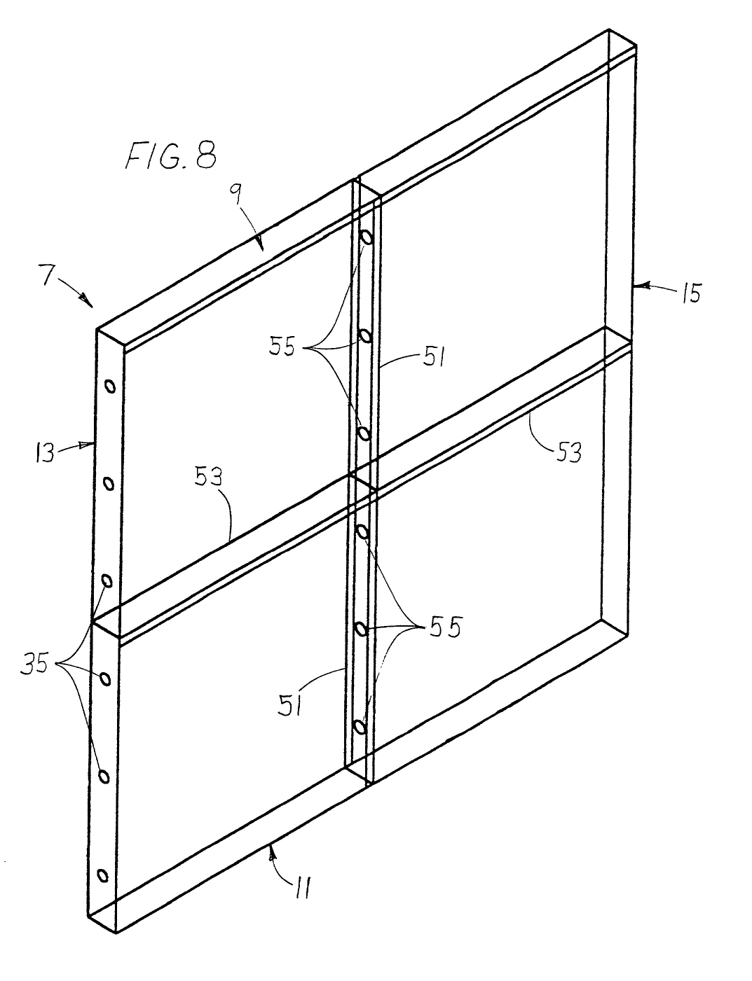

As shown in FIGS. 4-8, the door frame 7 may be strengthened by bracing extending across it in the space 25. FIG. 4 shows a brace 37 (e.g., a steel bar or other structural member) extending midheightwise horizontally across the frame from side 13 to side 15 and upper and lower inclined braces 39 and 41 (e.g. steel bars), the bracing triangulating the frame 7. FIG. 5 shows brace 37 and braces 43 and 45 similar to 39 and 41 but 43 oppositely inclined. FIG. 6 shows a single brace 47 extending diagonally with respect to the frame 7. FIG. 7 shows a single brace 49 extending vertically from top to bottom midway of the width of the frame 7. FIG. 8 shows vertical and horizontal braces 51 and 53 in a cruciform arrangement. Each of braces 39, 41, 43, 45, 47, 49 and 51 may have one or more openings such as holes 55 constituting passages for the foam material to permit uniform filling of the entire space 25.

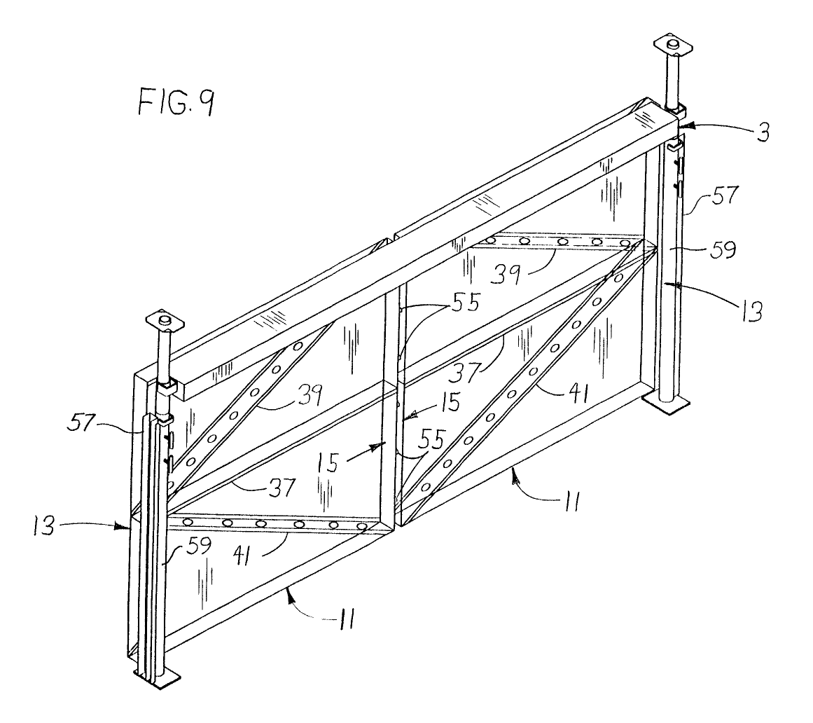

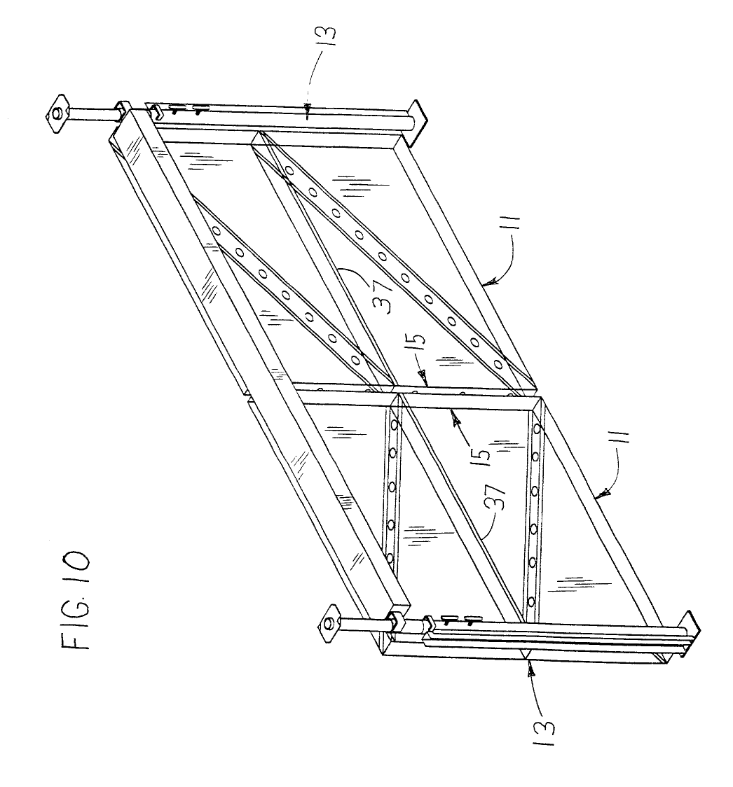

FIGS. 9 and 10 illustrate double-door leaf arrangements embodying door leafs with bracing such as shown in FIGS. 4 and 5, respectively. For the right-hand door leaf as shown, the foam filling holes 55 are in side 15 instead of 13. The doorway frame 3 illustrated in FIGS. 9 and 10 is generally of the type described above in regard to U.S. Pat. No. RE. 36,853. Outwardly opening channels 57 are affixed to the columns 59 of the doorway frame 3 for receiving stopping elements (not shown) used to close openings at opposite sides of the frame 3. Such elements may be vertically extensible panels of the type described in Kennedy U.S. Pat. No. 4,483,642, or concrete blocks, for example.

The construction comprising door frame 7, panels 21, 23 and filling 33 in its adherent force-transmitting bonding to the panels constitutes an integrated structure resistant to stresses to which the door leaf may be subjected including torsion-induced stresses (it has substantial torsional rigidity), shear and bending stresses, and such stress as may be induced by its own weight (albeit light). This results from the filling having strength in tension and compression and being bonded to the panels to transmit forces in the filling to the panels. The construction may be regarded as a generally laminar construction comprising the filling 33 as a central core (of relatively light weight) with the outer panels 21, 23 on opposite faces of the core.

The method of the invention of manufacturing the door leaf 5L or 5R comprises fabricating the door frame 7, and positioning door panels 21 and 23 on the door frame 7 in opposing spaced apart relation to enclose the space 25. Preferably, the panels are secured (as by welding, fasteners, adhesive, etc.) to opposite faces 24A, 24B of the frame 7, but it will be understood that the panels may be held loosely captive on or by the frame in other ways so long as they define, in combination with the door frame 7, enclosed space 25. After the panels 21, 23 have been positioned on the frame (and affixed thereto, if necessary), filling material is introduced in a fluent state into the space 25 through the filling opening(s) 35. After the space is filled, the filler material is allowed to set in situ to its solid state adhered (and/or mechanically coupled) to and thus in force-transmitting relationship with the panels. If the frame 7 is fabricated with bracing such as described, the fluent foam material flows through the passages 55 in the bracing and sets up therein. In the absence of passages 55, the foam material may be introduced through several different openings in the panels 21, 23 and/or door frame 7.

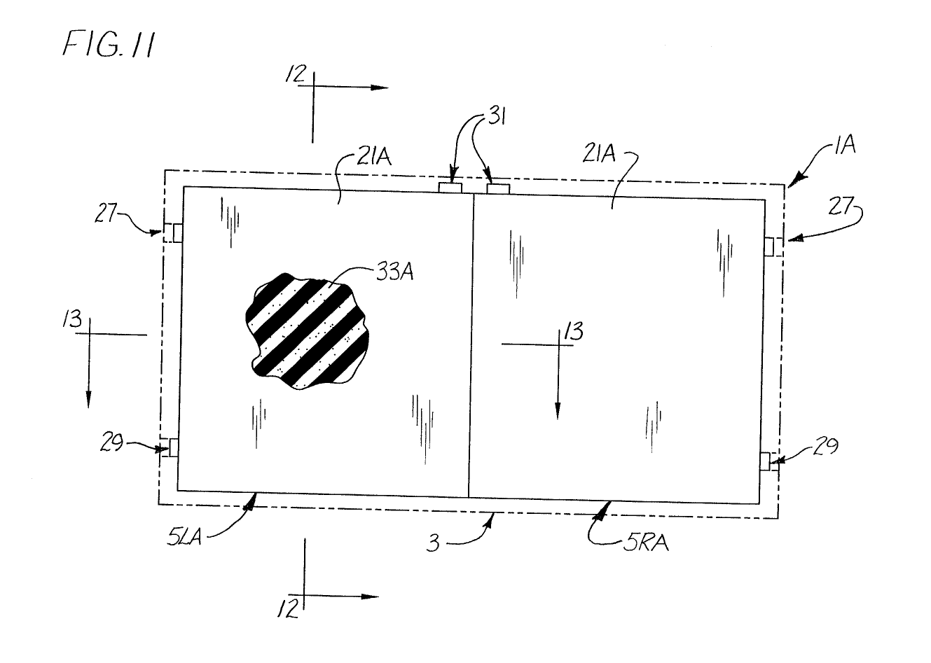

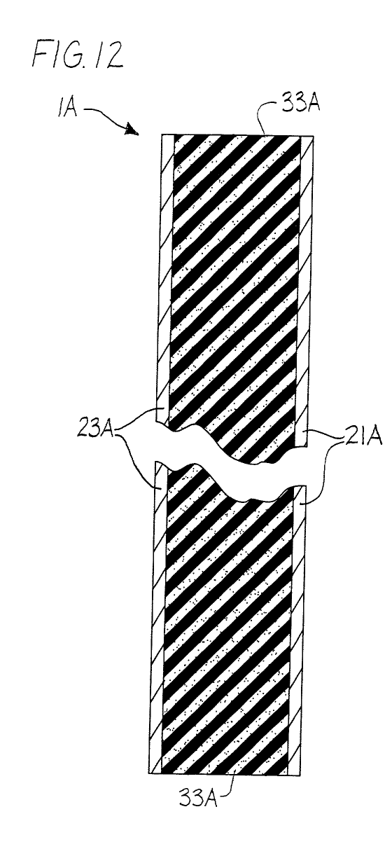

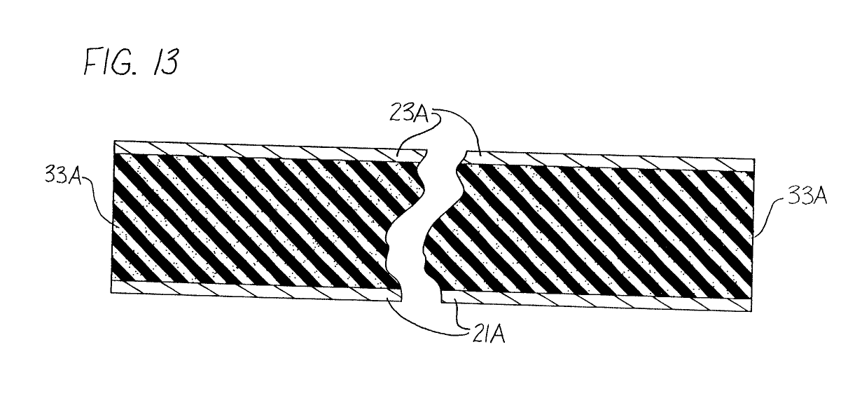

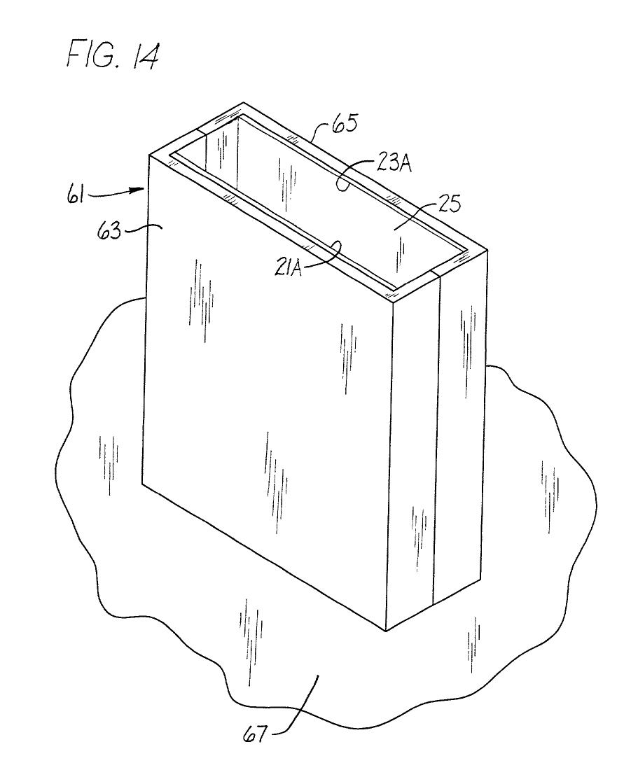

FIG. 11 illustrates a door assembly designated 1A in its entirety comprising modifications designated 5LA and 5RA of the leafs 5L and 5R each of frameless (unframed) laminar construction having a central core 33A of a solidified composition, preferably the same as described above, with outer panels 21A and 23A like panels 21 and 23 on opposite sides of the core. Here again, the core has a force-transmitting relationship with the panels so that the panels and core function as an integrated stress-resistant structure. Hinge components on the modification of the leaf are indicated at 27 and 29. The method of manufacturing the modified version of the leaf (the frameless version) involves placing the panels 21A and 23A in opposing spaced-apart relation in a mold 61 having separable parts 63 and 65 (FIG. 14), the mold standing on a non-stick surface 67, filling the space 25 between the panels (in the mold) with the filling composition in its fluent state (e.g. the aforesaid fire-resistant closed-cell polyurethane foam material), allowing the filling to set up and solidify, and then separating the mold parts and removing the leaf.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. A mine door leaf of generally laminar construction comprising a central core of a solidified composition, outer panels on opposite faces of the core, the core having a force-transmitting relationship with the panels constituting the panels and core as an integral stress-resistant structure, and one or more hinge components on the leaf.

2. A mine door leaf as set forth in claim 1 wherein the force-transmitting relationship is established by adhesion and/or mechanical coupling of the core to the panels.

3. A mine door leaf as set forth in claim 2 wherein the core comprises a fire-resistant foam material.

4. A mine door leaf as set forth in claim 3 wherein the core comprises a fire-resistant polyurethane foam material adherent to the panels thereby establishing the force-transmitting relationship.

5. A mine door leaf as set forth in claim 1 comprising a frame having a top, bottom and sides, the panels being secured on the frame in opposing spaced-apart relationship enclosing a space between the panels bounded by the top, bottom and sides of the frame, the core comprising a solidified filling in said space.

6. A mine door leaf as set forth in claim 5 wherein said door panels are secured to the top, bottom and sides of the frame on opposite faces of the frame.

7. A mine door leaf as set forth in claim 5 wherein the force-transmitting relationship is established by adhesion and/or mechanical coupling of the filling to the door panels.

8. A mine door leaf as set forth in claim 7 wherein the filling is a fire-resistant foam material.

9. A mine door leaf as set forth in claim 8 wherein the frame has one or more filling openings through which said filling was introduced in a fluent state.

10. A mine door leaf as set forth in claim 5 having bracing extending across the frame in said space.

11. A mine door leaf as set forth in claim 10 wherein the bracing triangulates the frame.

12. A mine door leaf as set forth in claim 10 wherein the filling is a fire-resistant polyurethane foam material adherent to the panels thereby establishing the force-transmitting relationship.

13. A mine door leaf as set forth in claim 12 wherein the frame has one or more filling openings through which the foam material was introduced in a fluent state and the bracing has one or more passages for the material.

14. A mine door leaf as set forth in claim 5 wherein the filling is a fire-resistant material having strength in tension and compression, and wherein the frame or one or more of the door panels has one or more filling openings through which said filling was introduced in a fluent state.

15. A mine door leaf as set forth in claim 14 having bracing extending across the frame in said space, the bracing having one or more passages for the material.

16. A mine door leaf as set forth in claim 1 of unframed construction.

17. A method of manufacturing a mine door leaf comprising positioning two door leaf panels in opposing spaced-apart relation and filling the space between the panels with material in a fluent state, the filling material setting in situ to a solid state in force-transmitting relationship with said panels.

18. The method of claim 16 wherein the filling material sets up adhering and/or mechanically coupled to the panels to establish the force-transmitting relationship.

19. The method of claim 18 wherein the filling material is a fire-resistant foam material.

20. The method of claim 19 wherein the filling material is a fire-resistant closed-cell polyurethane foam material.

21. The method of claim 17 comprising fabricating a frame having a top, bottom and sides, positioning the door panels on the frame in opposing spaced apart relation providing said space between the panels bounded by the top, bottom and sides of the frame, and filling the space with said filling material in a fluent state through one or more filling openings in the frame or panels.

22. The method of claim 21 wherein the door panels are positioned on the frame and secured thereto prior to filling said space.

23. The method of claim 21 wherein the filling material sets up adhering and/or mechanically coupled to the panels to establish said force-transmitting relationship.

24. The method of claim 23 wherein the filling material is a fire-resistant closed-cell polyurethane foam material.

25. The method of claim 21 wherein the frame is fabricated with bracing extending thereacross in said space.

26. The method of claim 25 wherein the fluent material flows through and sets up in passages in the bracing.

27. The method of claim 17 wherein the panels are placed in opposing spaced-apart relation in a mold for the filling of said space.

28. The method of claim 27 wherein the filling material sets up adhering and/or mechanically coupled to the panels to establish the force-transmitting relationship.

29. The method of claim 28 wherein the filling material is a fire-resistant foam material.

30. The method of claim 29 wherein the filling material is a fire-resistant closed-cell polyurethane foam material.
